(19) United States
(12) Patent Application Publication
(10) Pub. No.: US 2020/0286180 A1
(43) Pub. Date: Sep. 10, 2020

(54) METHOD AND SYSTEM FOR COMPUTING PORTFOLIO ALLOCATION RECOMMENDATIONS

(71) Applicant: JPMorgan Chase Bank, N.A., New York, NY (US)

(72) Inventors: William L. MAUCK, JR., Columbus, OH (US); Zhenyu JIA, Secaucus, NJ (US); Michael KISHELEV, South Orange, NJ (US)

(21) Appl. No.: 16/811,029

(22) Filed: Mar. 6, 2020

Related U.S. Application Data
(60) Provisional application No. 62/815,531, filed on Mar. 8, 2019.

(51) Int. Cl. G06Q 40/06; G06F 16/2457; G06N 20/00; G06N 5/04

(52) U.S. Cl. CPC G06Q 40/06; G06N 5/04; G06N 20/00; G06F 16/24578

(57) ABSTRACT

An embodiment of the present invention is directed to a portfolio insights observation engine. The observation engine performs: identifying a portfolio; identifying one or more goals and concerns specific to the portfolio; selecting a benchmark model portfolio; identifying a set of metrics for comparison between the portfolio and the benchmark model portfolio; evaluating one or more deviations relative to the set of metrics associated with the benchmark model portfolio; applying the one or more goals and concerns to the deviations; generating observations based on the benchmark portfolio; ranking the observations based on risk; identifying a subset of ranked observations; and providing, via the interactive interface, customized insights and solutions for each of the ranked observations.

### CROSS REFERENCE TO RELATED APPLICATIONS

The application claims priority to U.S. Provisional Application 62/815,531 (Attorney Docket No. 72167.001634), filed Mar. 8, 2019, the contents of which are incorporated herein in its entirety.

### FIELD OF THE INVENTION

The invention relates generally to a system and method for computing portfolio allocation recommendations and specifically to a portfolio insight observation engine that financial advisors may access to analyze portfolios relative to a benchmark.

### BACKGROUND OF THE INVENTION

Current systems approach portfolio allocation evaluation by developing a risk profile and a target for what that kind of volatility might look like. Advisors may then fine tune investments to have different target volatility. Other solutions break down a portfolio using factor analysis for a portion of the portfolio and determine how those factors might impact returns over times. However, such solutions are limited to a risk return profile and fail to provide a comprehensive solution to portfolio allocation evaluation.

These and other drawbacks exist.

### SUMMARY OF THE INVENTION

According to one embodiment, the invention relates to a system for computing portfolio allocation recommendations. The system comprises: a memory component that stores portfolio data and observations data; an interactive interface that communicates with a user via a network communication; and a processor coupled to the memory component and the interactive interface, the processor configured to perform the steps of: identifying a portfolio; identifying one or more goals and concerns specific to the portfolio; selecting a benchmark model portfolio; identifying a set of metrics for comparison between the portfolio and the benchmark model portfolio; evaluating one or more deviations relative to the set of metrics associated with the benchmark model portfolio; applying the one or more goals and concerns to the deviations; generating observations based on the benchmark portfolio; ranking the observations based on risk; identifying a subset of ranked observations; and providing, via the interactive interface, customized insights and solutions for each of the ranked observations.

According to another embodiment, the invention relates to a method for computing portfolio allocation recommendations. The method comprises the steps of: identifying, via an observation engine comprising a computer processor, a portfolio; identifying, via the observation engine, one or more goals and concerns specific to the portfolio; selecting, via the observation engine, a benchmark model portfolio; identifying, via the observation engine, a set of metrics for comparison between the portfolio and the benchmark model portfolio; evaluating, via the observation engine, one or more deviations relative to the set of metrics associated with the benchmark model portfolio; applying, via the observation engine, the one or more goals and concerns to the deviations; generating, via the observation engine, observations based on the benchmark portfolio; ranking, via the observation engine, the observations based on risk; identifying, via the observation engine, a subset of ranked observations; and providing, via an interactive interface, customized insights and solutions for each of the ranked observations.

The computer implemented system and method described herein provide unique advantages to financial institutions, financial advisors, asset management professionals, clients, portfolio managers and other users, according to various embodiments of the invention. An embodiment of the present invention is directed to analyzing a multitude of different elements of an asset allocated model investment portfolio for a client and identifying differences in allocation relative to a benchmark. An embodiment of the present invention further presents potential risks and/or opportunities and accordingly highlights the most relevant and interesting issues to the financial adviser. An embodiment of the present invention uniquely leverages risk management and model portfolio allocation to fine-tune a model relative to the benchmark based on goals of the portfolio, which may include income increase, growth increase, capital preservation, risk mitigation as well as other concerns such as rising interest rates, portfolio volatility and equity markets volatility. These and other advantages will be described more fully in the following detailed description.

### BRIEF DESCRIPTION OF THE DRAWINGS

In order to facilitate a fuller understanding of the present invention, reference is now made to the attached drawings. The drawings should not be construed as limiting the present invention, but are intended only to illustrate different aspects and embodiments of the invention.

FIG. 1 is an exemplary application flow, according to an embodiment of the present invention.

FIG. 2 is an exemplary flow diagram of digital portfolio insights and benchmark, according to an embodiment of the present invention.

FIG. 3 is an exemplary flow diagram of an Observation Engine, according to an embodiment of the present invention.

FIG. 4 is an exemplary user interface, according to an embodiment of the present invention.

FIG. 5 is an exemplary user interface, according to an embodiment of the present invention.

FIG. 6 is an exemplary user interface, according to an embodiment of the present invention.

FIG. 7 is an exemplary system diagram, according to an embodiment of the present invention.

### DETAILED DESCRIPTION OF THE PREFERRED EMBODIMENT(S)

The following description is intended to convey an understanding of the present invention by providing specific embodiments and details. It is understood, however, that the present invention is not limited to these specific embodiments and details, which are exemplary only. It is further understood that one possessing ordinary skill in the art, in light of known systems and methods, would appreciate the use of the invention for its intended purposes and benefits in any number of alternative embodiments, depending upon specific design and other needs.

An embodiment of the present invention is directed to implementing an Insights Observation Engine. According to an embodiment of the present invention, the Observation Engine may employ a sophisticated algorithm to dynamically evaluate an investment portfolio relative to a benchmark/model identifying and prioritizing risks and/or opportunities based observations. For example, observations may be based on a multitude of metrics including relative asset allocation deviations, relative and risk adjusted performance comparisons, thematic allocation opportunities, market and economic stress tests, as well as potential performance risk and asset allocation risk evaluations. The Observation Engine's algorithm may customize the evaluation and the resulting observations by incorporating user selected (or user based) investment goals and risk appetite (e.g., market or event) into its assessment process. The Observation Engine may further dynamically leverage aggregated holdings and returns based data driven from the relative weights of the portfolio's underlying investments and contrasts relative to a benchmark/model. The benchmark/model employed in the evaluation may be user selected and/or Observation Engine suggested, based on a holdings and returns based assessment of the portfolio relative to a known universe of risk adjusted benchmarks/models. Other considerations from various sources may be applied. The Observation Engine may prioritize the resulting observations by risk and/or opportunity revealing a set of items to review, e.g., the most critical items to review. Further, the Observation Engine may provide suggested actions to resolve the identified risks and uncaptured opportunities while integrating market, economic and/or investment outlook data to support conclusions.

Based on a model portfolio, an embodiment of the present invention may suggest a relevant asset management view on asset allocation and/or benchmark. A benchmark may represent a standard or measure that may be used to analyze the allocation, risk and return of a given portfolio. An originating entity (e.g., financial institution, etc.) may have access to various levels of insights and analytics for the benchmark portfolio. In addition, an embodiment of the present invention may leverage benchmark portfolios generated from external sources, e.g., another financial institution. Depending on the source and quality of data available from the benchmark portfolio, the observations provided may vary.

An embodiment of the present invention is directed to a robust digital portfolio construction tool that provides diagnostics, observations and/or supporting content to help advisors build stronger portfolios and communicate their rationale with clarity and ease.

The system may provide diagnostics and other analytics that financial advisors can understand and use. The system further helps identify risk and return drivers, uncover new investment opportunities, fine-tune portfolio allocations and perform other analytics and actions. In addition, the system provides integrated insights to support rationale via an interactive user interface or other output.

The system provides portfolio observations and explanations (e.g., high level and detailed) and further uses risk and portfolio management systems. The system may be web based and accessible from any browser via a device (e.g., mobile device, etc.) for various users, including Financial Advisors.

An embodiment of the present invention may further provide fully integrated market insights and retirement insights “case for” packs to support rationale; portfolio export functionality. “Case for” may represent market insights and retirement insights program content. This may include observation content to add education information about the asset class, economics or investing behavior to further explain why the observation makes sense to address. The system may further provide factor analysis, investment product analysis (e.g., Fund v. Fund) and investment heatmaps and/or other interactive features. In addition, the system may provide white label offering, internationalization and artificial intelligence (AI). An embodiment of the present invention may allow for integration into partner firms websites, allowing non U.S. investments and users to leverage the system as well as provide ways to add artificial intelligence to the system for a more interactive and guided experience.

According to an embodiment of the present invention, the Observation Engine may apply machine learning to adapt and improve the ability to identify relevant observations about portfolios to financial advisors. The Observation Engine may consider real time analyst data as well as metrics and inputs from various sources, including internal to a financial entity as well as external sources. Accordingly, the Observation Engine may apply machine learning to refine and fine-tune observations for an optimal and highly personalized view. For example, Observation Engine may apply machine learning to determine an optimal or most appropriate benchmark (or benchmark factors/characteristics) and further determine observations based on the identified benchmark.

According to an embodiment of the present invention, an output of the Observation Engine may be presented to a user, e.g., human analyst, asset management professionals, etc. In this example, the user may perform various actions, which may include altering an order of observations, creating customized observations, modifying existing observations, etc. A collective set of human-guided observations may then become “data labeling,” which may be used for supervised machine learning to further improve future Observation engine outputs. An embodiment of the present invention may implement various learning models, including human-in-the-loop learning (HitL) model.

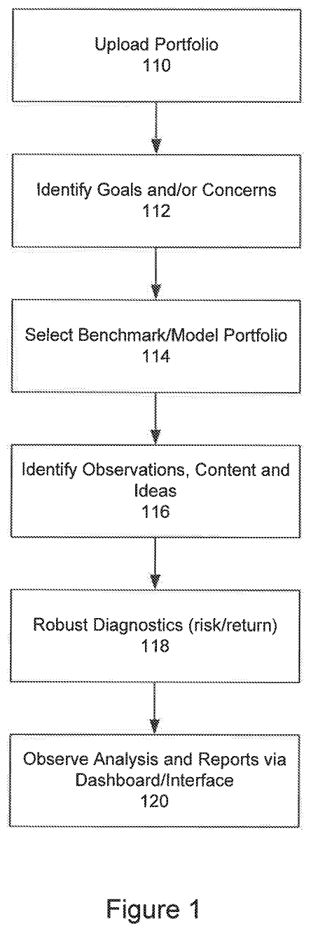

FIG. 1 is an exemplary application flow, according to an embodiment of the present invention. At step 110, a portfolio may be uploaded. At step 112, goals and concerns may be identified. At step 114, a benchmark and/or model portfolio may be selected. For example, a most relevant benchmark may be suggested based on a model portfolio. At step 116, observations, supporting content and/or investment ideas may be received. At step 118, the system may provide robust diagnostics including contribution to risk and/or return. At step 120, a dashboard may provide past analysis and client-friendly reports as well as other outputs and interfaces. The order illustrated in FIG. 1 is merely exemplary. While the process of FIG. 1 illustrates certain steps performed in a particular order, it should be understood that the embodiments of the present invention may be practiced by adding one or more steps to the processes, omitting steps within the processes and/or altering the order in which one or more steps are performed.

An embodiment of the present invention may consider a mix of various different holdings and returns base matrix to evaluation differences between the model portfolio and the benchmark and further customize the evaluation based on goals and/or concerns in the marketplace. An embodiment of the present invention is directed to a combination of returns-based and holdings-based information on underlying products. The system may further customize outputs of the evaluation based on the goals of the portfolio and concerns around risk in the portfolio. In addition, the system may adapt to changes and/or modifications in terms of goals and concerns as the environment is constantly changing, e.g., interest rates, etc.

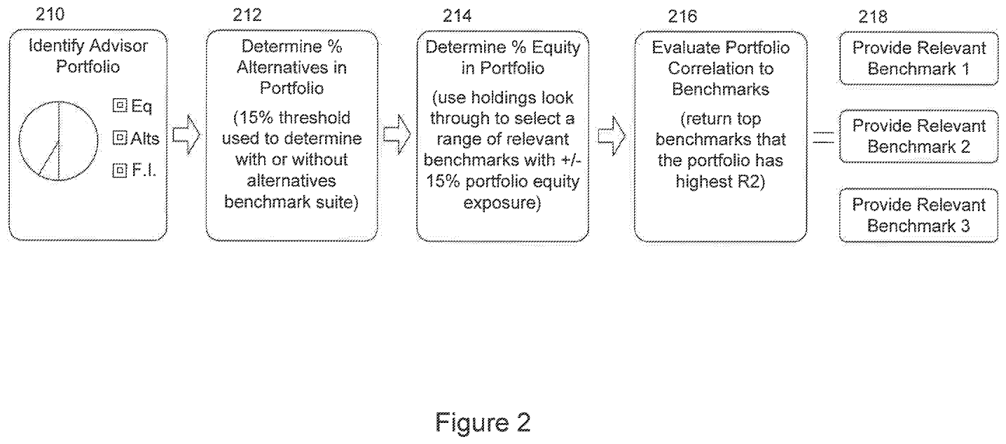

FIG. 2 is an exemplary flow diagram of digital portfolio insights and benchmark, according to an embodiment of the present invention. An embodiment of the present invention is directed to providing guidance to advisors to select an appropriate benchmark for their portfolio. Additionally, the innovative tool offers the ability for the advisor to build a customized benchmark or model portfolios to contrast their advisor portfolio. As shown in FIG. 2, an Advisor Portfolio may be identified at 210. At 212, a percentage of alternatives in a portfolio may be determined. For example, a predetermined percentage threshold (e.g., +/−15%) may be used to determine with or without alternatives benchmark suite. At 214, a percentage of equity in the portfolio may be determined. This may involve using a holdings look through to select a range of relevant benchmarks. For example, the system may select benchmarks with +/−15% portfolio equity exposure. Other percentages or calculations may be applied. The system may then evaluate portfolio correlation to benchmarks, as shown by 216. According to an exemplary scenario, the system may return a top number of benchmarks, represented by 218, that the portfolio has a highest R2. R-squared (R2) may represent a statistical measure of how close the data are to the fitted regression line. R-squared may be interpreted as the percentage of a portfolio or security's movements that may be explained by movements in a benchmark. This may be used in an embodiment of the present invention to guide the user to the best fit benchmark. As shown in FIG. 2, the system identifies three representative benchmarks. R2 is one exemplary measure; other statistical measurements and calculations may be applied.

An embodiment of the present invention is directed to an Observation Engine that custom tailors evaluation and resulting observations based on portfolio goals and/or volatility concerns. For example, current goal choices may include increase income, improve growth, preserve capital, etc. Current volatility concerns may include minimize impact of rising interest rates and minimize impact of equity market volatility. Other goals and concerns may be applied. The Observation Engine may further evaluate the advisor's portfolio across various holdings and risk/return based metrics relative to a benchmark/model and provide a top number of actionable opportunities. For example, holding based metrics may include: Equity U.S. vs. International Exposure; Equity Region—European vs. Asian Exposure; Equity Developed vs. Emerging Markets Exposure; Equity Style—Value vs. Growth; Equity Market Capitalization—Large vs. Small; Equity Sector Balance; Exposure to Real Estate; Fixed Income U.S. vs International Exposure; Fixed Income Duration Profile; Fixed Income Sector Balance; Fixed Income Credit Quality Dispersion; and Cash Exposure.

Risk/Return based metrics may include: Stress Test Sensitivity (e.g., currently: Equity Market Volatility (e.g., performance when equity markets sold off) and Rising Interest Rate Volatility (e.g., performance when interest rates rose)); Returns; Sharpe Ratio; Up Market vs Down Market Capture; and Yield.

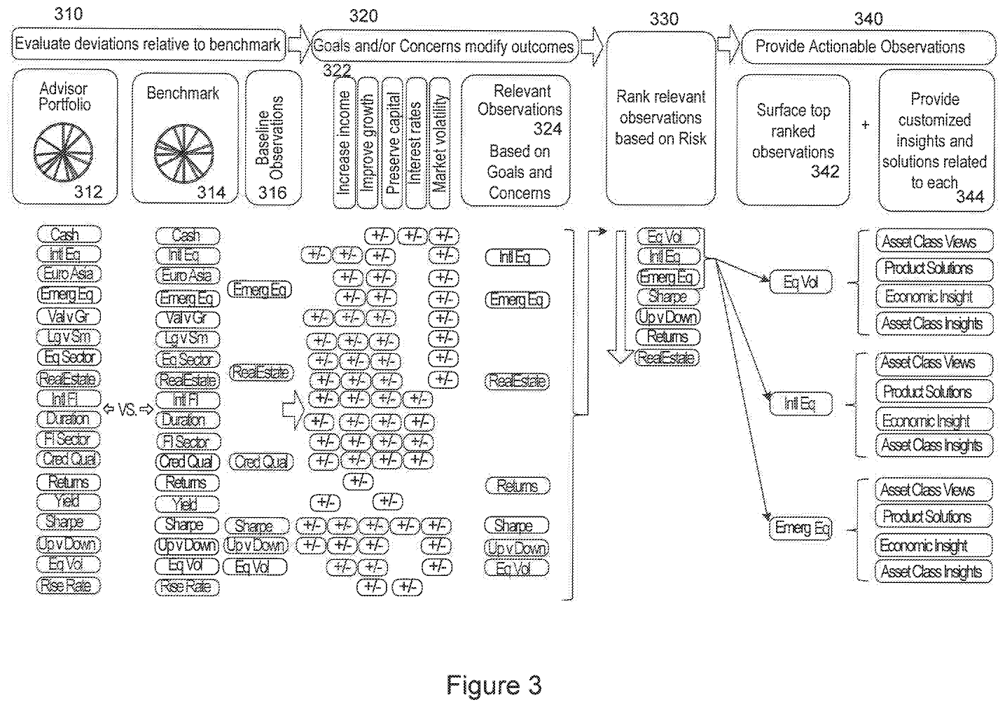

FIG. 3 is an exemplary flow diagram of an Observation Engine, according to an embodiment of the present invention. An Advisor Portfolio may be contrasted relative to a chosen benchmark or model. As shown in FIG. 3, the process may evaluate deviations relative to benchmark at 310. An embodiment of the present invention may identify differences (e.g., asset allocation differences, etc.) between the Advisor Portfolio 312 and Benchmark 314 with respect to a set of metrics. The set of metrics shown in FIG. 3 is illustrative and may include other considerations including e.g., deviation evaluations, scenario, analysis evaluations, stress factor test evaluations, etc. The comparison may be used to identify Baseline Observations 316. At 320, goals and/or concerns may modify outcomes. For example, goals and concerns may include increase income, improve growth, preserve capital, interest rates and market volatility, as shown by 322. In addition, 322 may include other goals and concerns including asset class relevant tilt, for example. Other goals and/or concerns may be applied to refine and customize the observations. An embodiment of the present invention may then identify a set of relevant observations based on the goals and/or concerns, as shown by 324. At 330, the process may rank relevant observations based on a factor, such as risk. Other rankings and/or factors may be applied in accordance with the various embodiments of the present inventions. An embodiment of the present invention is directed to custom tailoring portfolio observations and to identify a set of important/relevant observations for additional analysis and exploration. At 340, actionable observations may be provided. In the example of FIG. 3, three top observations may include Equity Market Volatility (Eq Vol), International Equity Exposure (Intl Eq) and Emerging Markets Equity (Emerg Eq) as shown by 342. The number of observations and details may vary. These observations may be presented to facilitate portfolio alignment with the benchmark based on a specific set of goals and/or concerns. As shown by 344, customized insights and solutions may be provided. For each observation, a corresponding set of insights may include asset class views, product solutions, economic insight, asset class insights, for example.

According to an embodiment of the present invention, Observation Engine considers risks, such as equity market volatility, as compared to observations, such as the amount of real estate exposure associated with a portfolio. Another observation may include having too many high-quality government bonds in the portfolio. This may be measured as bonds above a predetermined threshold. An embodiment of the present invention is directed to considering the composition of the portfolio. This may be represented by the metrics illustrated in 310. For example, in an exemplary portfolio that is more risk comfortable and looking to drive more growth, the portfolio may include 80% in equities and 20% in fixed income. Another portfolio for someone in retirement may have a composition that is driven toward fixed income. The risk of fixed income in the exemplary portfolio may be more driven by equity exposure and goals towards accumulation. An embodiment of the present invention is directed to differentiating risks and determining that a certain risk, e.g., equity type risk, is more important to a particular portfolio. An embodiment of the present invention is directed to improving observations by incorporating an enhanced understanding of the composition of the portfolio to better fine tune the observations for improved relevancy. Accordingly, an embodiment of the present invention may be driven by the risks and the goals that may be selected or suggested to the client and further customized to be more relevant and highly aligned with the composition of the portfolio. For example, when a portfolio is more orientated towards an equity accumulation, an embodiment of the present invention may provide observations relevant to equities. For a portfolio that is more driven towards an income oriented portfolio with more bonds that, an embodiment of the present invention may tailor the analysis to bonds.

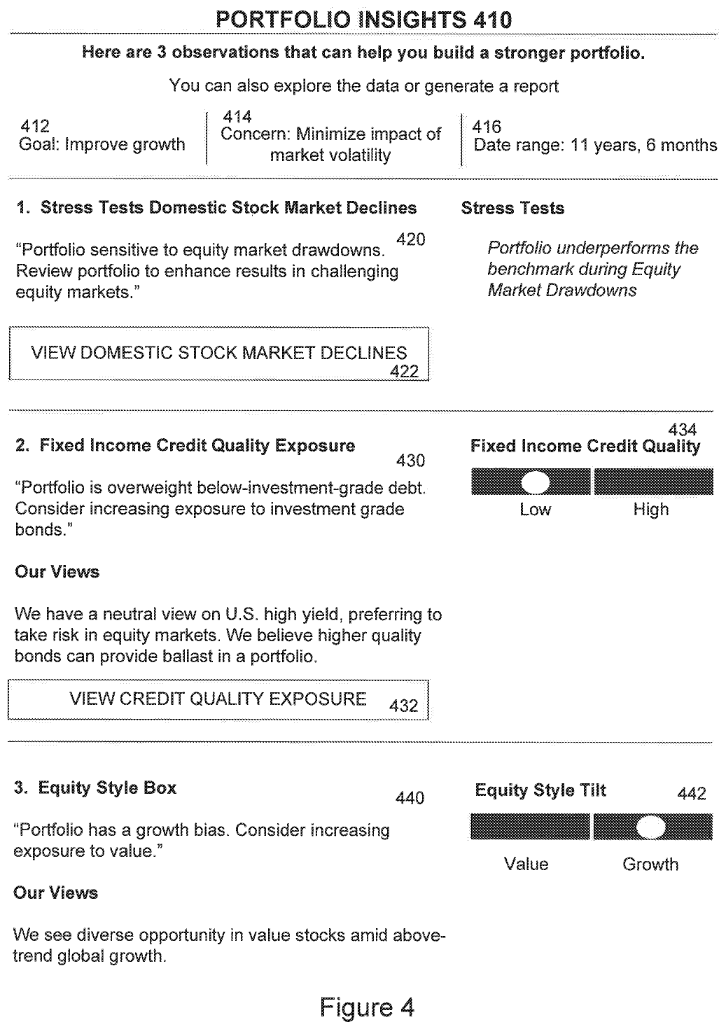

FIG. 4 is an exemplary user interface, according to an embodiment of the present invention. An embodiment of the present invention is directed to identifying opportunities, including insights and potential solutions (e.g., insights, product ideas, economic information, etc.). As shown in FIG. 4, Portfolio Insights Interface 410 may provide customized observations based on Goal 412, Concern 414 and Date Range 416. Other considerations may be applied. FIG. 4 illustrates an exemplary set of observations to build a stronger portfolio. The observations include insights relating to Stress Tests 420, Fixed Income Credit Quality 430 and Equity Style 440 with corresponding details and data. Other metrics and data may be made available to the user. For example, a user may view additional data, such as domestic stock market declines 422, credit quality exposure 432, fixed income credit quality 434 and equity style tilt 442.

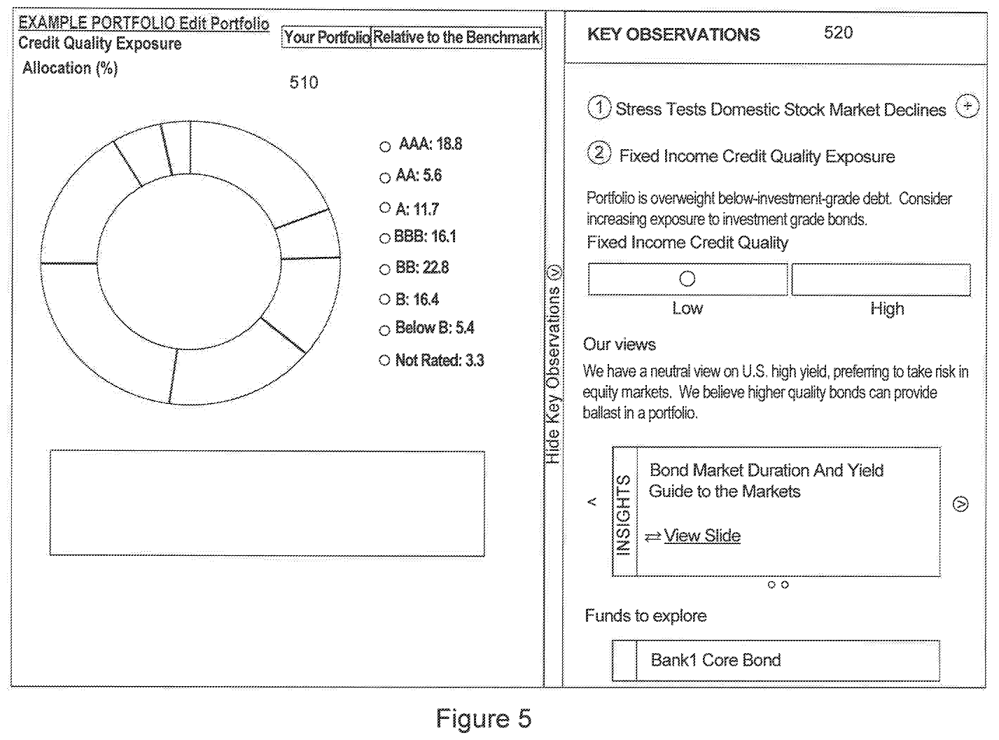

FIG. 5 is an exemplary user interface, according to an embodiment of the present invention. As shown in FIG. 5, the system illustrates credit quality exposure based on allocation percentage at 510. Other illustrations and graphics may be applied. FIG. 5 also illustrates key observations 520. This may include details concerning Stress Tests and Fixed Income Credit Quality Exposure, for example. Additional details may include views, insights and funds to explore.

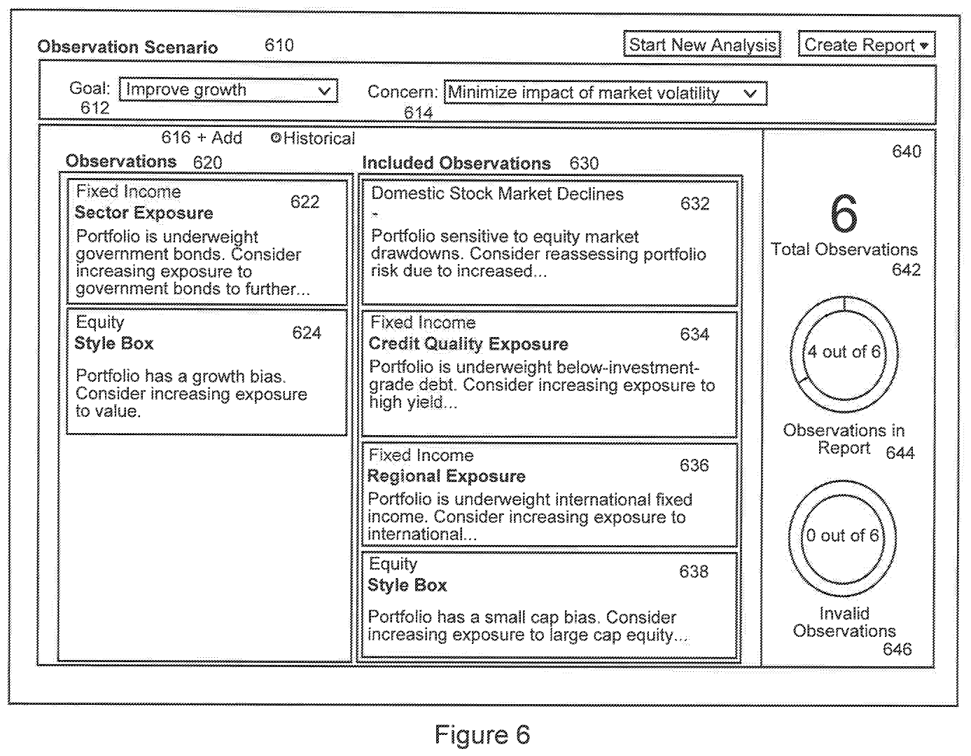

FIG. 6 is an exemplary user interface, according to an embodiment of the present invention. According to an embodiment of the present invention, an output of the Observation Engine may be presented to a user, e.g., human analyst, asset management professionals, etc. In this example, the user may provide inputs to an output generated by the Observation Engine. This may include altering an order of observations, modifying an observation, deleting an observation, creating a customized observation, etc. An embodiment of the present invention may identify the user inputs and then apply various learning models to further refine and optimize the Observation Engine. This may involve applying a human-in-the-loop learning (HitL) model.

FIG. 6 illustrates an exemplary Observation Scenario 610. As shown in FIG. 6, a user may start a new analysis, create report and/or perform other actions. In this example, a user may select Goal 612 and Concern 614, via a drop down window or other user input. The user may also add observations at 616, modify the identified observations, re-rank or change order of observations (e.g., drag and drop) as well as perform other actions and changes. Observations 620 may include Fixed Income Sector Exposure 622 and Equity Style Box 624. Included Observations 630 may include Domestic Stock Market Declines 632, Fixed Income Credit Quality Exposure 634, Fixed Income Regional Exposure 636 and Equity Style Box 638. Interface 640 may provide a summary of Total Observations 642 and details concerning Observations in Report 644 and Invalid Observations 646.

As shown in FIG. 6, a user may provide an input to adjust the provided observations. The user may represent an asset management professional or other qualified user. An embodiment of the present invention may enable the user to evaluate the observation output, as shown in FIG. 6, and then refine the observations based on experience, personal insights and/or other information. For example, the user may observe a set of highest ranked observations generated by the Observation Engine and then adjust the findings, which may include reordering the observations, adding an observation, removing an observation, modifying/changing an observation and/or other modification. This may involve fine-tuning the observations to better align with a financial or other goal, e.g., refine observations to be more equity-oriented as opposed to fixed income based. An embodiment of the present invention may then apply the captured user inputs to refine the Observation Engine.

User input and adjustment may be received and considered in various stages of the present invention. As shown in FIG. 3, user input and adjustment may be applied at various stages of the process, including Baseline Observations 316, Relevant Observations 324 and Rank Relevant Observations 330. For example, a user input may relate to an adjustment in ranking the relevant observation as shown by 330. User input and adjustment may be applied to a single instance and/or multiple instances throughout the process. Other inputs, adjustment and/or variations may be applied.

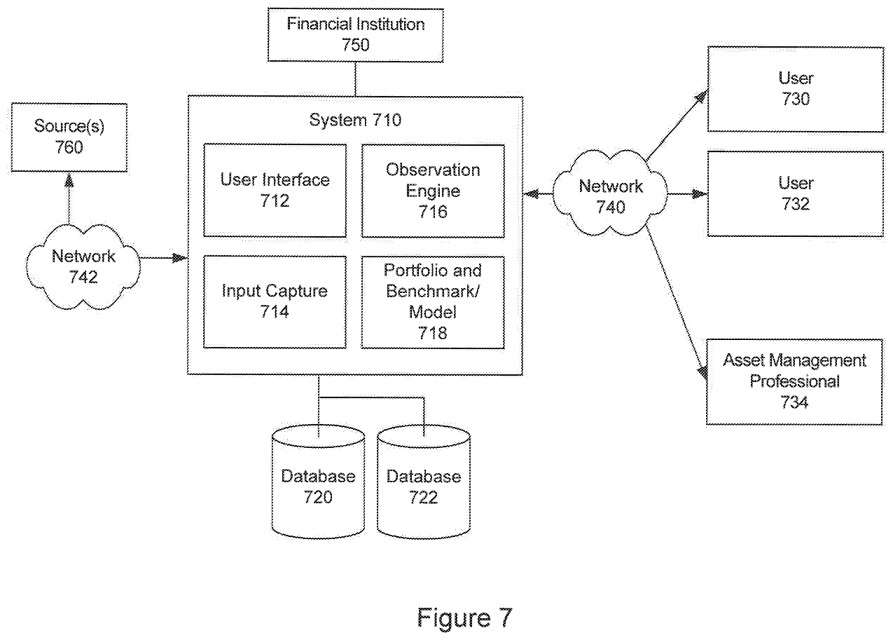

FIG. 7 is an exemplary system diagram, according to an embodiment of the present invention. As shown in FIG. 7, a user may access System 710 through a client device or system. Users 730, 732, 734 may include financial advisors, asset management professionals, analysts and/or other users. System 710 may represent a portfolio allocation recommendation system with various processing components represented by User Interface 712, Input Capture 714, Observation Engine 716 and Portfolio 718. Other components, modules and/or interfaces may be implemented in System 710. The components illustrated in FIG. 7 are merely exemplary, other devices may be represented in various applications. While a single component is illustrated, each component may represent multiple components and multiple components may be combined and/or integrated.

Users, represented by 730, 732, 734, of an embodiment of the present invention may communicate with System 710 via Network 740 through a User Interface, represented by 712. Communication may be performed using any mobile or computing device, such as a laptop computer, a personal digital assistant, a smartphone, a smartwatch, smart glasses, other wearables or other computing devices capable of sending or receiving network signals.

User Interface 712 may represent an interface user interface or dashboard that receives user initiation and/or other actions and further provides observations. Via a user interface, Observation Engine 714 may prioritize the resulting observations by risk and opportunity revealing high priority items to review. Further, the Observation Engine may provide suggested actions to resolve the identified risks and uncaptured opportunities while integrating market, economic and/or investment outlook data to support conclusions. According to an embodiment of the present invention, Input Capture 714 may receive input from an Asset Management Professional represented by 734 to refine and adjust observations provided by Observation Engine 716 at various stages.

Observation Engine 716 may dynamically evaluate an investment portfolio relative to a benchmark/model and further identify and prioritize risks and/or opportunities based observations. According to an exemplary scenario, observations may be based on various metrics and considerations including relative asset allocation deviations, relative and risk adjusted performance comparisons, thematic allocation opportunities, market and economic stress tests, as well as potential performance risk and asset allocation risk evaluations. In addition, Observation Engine 716 is directed to customizing the evaluation and observations by incorporating investment goals and risk considerations. Observation Engine 716 may further dynamically leverage aggregated holdings and returns based data driven from the relative weights of the portfolio's underlying investments and contrasts relative to a benchmark/model.

Portfolio and Benchmark/Model 718 may represent and manage portfolio and benchmark/model data. For example, the benchmark/model employed in an evaluation may be user selected and/or Observation Engine suggested, based on a holdings and returns based assessment of the portfolio relative to a known universe of risk adjusted benchmarks/models.

An embodiment of the present invention may communicate, via Network 742, with internal and external sources of data, represented by Source 760.

An entity, such as a Financial Institution 750, may host System 710 according to an embodiment of the present invention. The entity may support portfolio allocation recommendations and observation engine functionality as an integrated feature or system. According to another example, portfolio allocation recommendations and observation engine services may be offered by a third party service provider. Other scenarios and architectures may be implemented. An embodiment of the present invention may send and/or receive data from various other sources represented by databases 720, 722. Databases may be internal or external to a host entity. Data may be stored and managed in storage components via one or more networks. Databases may include any suitable data structure to maintain the information and allow access and retrieval of the information. The storage may be local, remote, or a combination thereof with respect to Databases. Communications with Databases may be over a network, or communications may involve a direct connection between Databases and other participants, as depicted in FIG. 7. Databases may also represent cloud or other network based storage or an application presenting a data source via an API.

The system 700 of FIG. 7 may be implemented in a variety of ways. Architecture within system 700 may be implemented as hardware components (e.g., module) within one or more network elements. It should also be appreciated that architecture within system 700 may be implemented in computer executable software (e.g., on a tangible, non-transitory computer-readable medium) located within one or more network elements. Module functionality of architecture within system 700 may be located on a single device or distributed across a plurality of devices including one or more centralized servers and one or more mobile units or end user devices. The architecture depicted in system 700 is meant to be exemplary and non-limiting. For example, while connections and relationships between the elements of system 700 are depicted, it should be appreciated that other connections and relationships are possible. The system 700 described below may be used to implement the various methods herein, by way of example. Various elements of the system 700 may be referenced in explaining the exemplary methods described herein.

The various features of an embodiment of the present invention may be applied to other applications, uses and scenarios. For example, an embodiment of the present invention may be applied to procurement decisions and other hardware, configuration and infrastructure decisions. An embodiment of the present invention may be applied to identify underlying trends and patterns to address various automation incompatibilities and other issues.

The foregoing examples show the various embodiments of the invention in one physical configuration; however, it is to be appreciated that the various components may be located at distant portions of a distributed network, such as a local area network, a wide area network, a telecommunications network, an intranet and/or the Internet. Thus, it should be appreciated that the components of the various embodiments may be combined into one or more devices, collocated on a particular node of a distributed network, or distributed at various locations in a network, for example. As will be appreciated by those skilled in the art, the components of the various embodiments may be arranged at any location or locations within a distributed network without affecting the operation of the respective system.

As described above, the various embodiments of the present invention support a number of communication devices and components, each of which may include at least one programmed processor and at least one memory or storage device. The memory may store a set of instructions. The instructions may be either permanently or temporarily stored in the memory or memories of the processor. The set of instructions may include various instructions that perform a particular task or tasks, such as those tasks described above. Such a set of instructions for performing a particular task may be characterized as a program, software program, software application, app, or software.

It is appreciated that in order to practice the methods of the embodiments as described above, it is not necessary that the processors and/or the memories be physically located in the same geographical place. That is, each of the processors and the memories used in exemplary embodiments of the invention may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two or more pieces of equipment in two or more different physical locations. The two distinct pieces of equipment may be connected in any suitable manner. Additionally, the memory may include two or more portions of memory in two or more physical locations.

In the system and method of exemplary embodiments of the invention, a variety of “user interfaces” may be utilized to allow a user to interface with the mobile devices or other personal computing device. As used herein, a user interface may include any hardware, software, or combination of hardware and software used by the processor that allows a user to interact with the processor of the communication device. A user interface may be in the form of a dialogue screen provided by an app, for example. A user interface may also include any of touch screen, keyboard, voice reader, voice recognizer, dialogue screen, menu box, list, checkbox, toggle switch, a pushbutton, a virtual environment (e.g., Virtual Machine (VM)/cloud), or any other device that allows a user to receive information regarding the operation of the processor as it processes a set of instructions and/or provide the processor with information. Accordingly, the user interface may be any system that provides communication between a user and a processor. The information provided by the user to the processor through the user interface may be in the form of a command, a selection of data, or some other input, for example.

The software, hardware and services described herein may be provided utilizing one or more cloud service models, such as Software-as-a-Service (SaaS), Platform-as-a-Service (PaaS), and Infrastructure-as-a-Service (IaaS), and/or using one or more deployment models such as public cloud, private cloud, hybrid cloud, and/or community cloud models.

Although the embodiments of the present invention have been described herein in the context of a particular implementation in a particular environment for a particular purpose, those skilled in the art will recognize that its usefulness is not limited thereto and that the embodiments of the present invention can be beneficially implemented in other related environments for similar purposes.

What is claimed is:

1. A system for implementing a portfolio insights observation engine, the system comprising:
a memory component that stores portfolio data and observations data;
an interactive interface that communicates with a user via a network communication; and
a processor coupled to the memory component and the interactive interface, the processor configured to perform the steps of:
identifying a portfolio;
identifying one or more goals and concerns specific to the portfolio;
selecting a benchmark model portfolio;
identifying a set of metrics for comparison between the portfolio and the benchmark model portfolio;
evaluating one or more deviations relative to the set of metrics associated with the benchmark model portfolio;
applying the one or more goals and concerns to the deviations;
generating observations based on the benchmark portfolio;
ranking the observations based on risk;
identifying a subset of ranked observations; and
providing, via the interactive interface, customized insights and solutions for each of the ranked observations.

2. The system of claim 1, wherein the processor is further configured to: receive a user input relating to the observations.

3. The system of claim 2, wherein the user input relating to the observations comprises re-ranking of the observations.

4. The system of claim 2, wherein the user input relating to the observations comprises modifying one or more observations.

5. The system of claim 2, wherein the user input relating to the observations comprises adding a new observation to the observations.

6. The system of claim 1, wherein the user input relating to the observations is used to refine the observation engine via machine learning.

7. The system of claim 6, wherein the machine learning comprises a human-in-the-loop learning model.

8. The system of claim 1, wherein the one or more goals and concerns comprise increase income, improve growth, preserve capital, interest rates and market volatility.

9. The system of claim 1, wherein the applying the one or more goals and concerns to the deviations further comprises making one or more adjustments to one or more metrics of the set of metrics.

10. The system of claim 1, wherein the customized insights and solutions comprise a portfolio insights interface.

11. A method for implementing a portfolio insights observation engine, the method comprising the steps of:
identifying, via an observation engine comprising a computer processor, a portfolio;
identifying, via the observation engine, one or more goals and concerns specific to the portfolio;
selecting, via the observation engine, a benchmark model portfolio;
identifying, via the observation engine, a set of metrics for comparison between the portfolio and the benchmark model portfolio;
evaluating, via the observation engine, one or more deviations relative to the set of metrics associated with the benchmark model portfolio;
applying, via the observation engine, the one or more goals and concerns to the deviations;
generating, via the observation engine, observations based on the benchmark portfolio;
ranking, via the observation engine, the observations based on risk;
identifying, via the observation engine, a subset of ranked observations; and
providing, via an interactive interface, customized insights and solutions for each of the ranked observations.

12. The method of claim 11, wherein the processor is further configured to: receive a user input relating to the observations.

13. The method of claim 12, wherein the user input relating to the observations comprises re-ranking of the observations.

14. The method of claim 12, wherein the user input relating to the observations comprises modifying one or more observations.

15. The method of claim 12, wherein the user input relating to the observations comprises adding a new observation to the observations.

16. The method of claim 11, wherein the user input relating to the observations is used to refine the observation engine via machine learning.

17. The method of claim 16, wherein the machine learning comprises a human-in-the-loop learning model.

18. The method of claim 11, wherein the one or more goals and concerns comprise increase income, improve growth, preserve capital, interest rates and market volatility.

19. The method of claim 11, wherein the applying the one or more goals and concerns to the deviations further comprises making one or more adjustments to one or more metrics of the set of metrics.

20. The method of claim 11, wherein the customized insights and solutions comprise a portfolio insights interface.
